(19) United States
(12) Patent Application Publication
(10) Pub. No.: US 2021/0383261 A1
(43) Pub. Date: Dec. 9, 2021

(54) MACHINE LEARNING SYSTEMS FOR COLLABORATION PREDICTION AND METHODS FOR USING SAME

(71) Applicant: Job Market Maker, LLC, Charleston, SC (US)

(72) Inventors: Joseph W. Hanna, Charleston, SC (US); David Trachtenberg, Charleston, SC (US); Christina R. Petrosso, Folly Beach, SC (US)

(21) Appl. No.: 17/341,095

(22) Filed: Jun. 7, 2021

Related U.S. Application Data
(60) Provisional application No. 63/035,379, filed on Jun. 5, 2020.

(51) Int. Cl. G06N 5/04; G06N 20/00

(52) U.S. Cl. CPC G06N 5/04; G06N 20/00

(57) ABSTRACT

A machine learning system can include a data store and a computing device in communication with the data store. The data store can include entity data. The computing device can receive data describing at least one aspect of a position for the entity. The computing device can generate metadata for the position based on the data describing the at least one aspect, the metadata including a plurality of skills and tasks associated with the position. The computing device can identify task locations for the entity and determine a distribution of capacity across the same based on entity data. The computing device can determine physical proximity scores for each skill and task based on the metadata and the corresponding distribution of capacity. The computing device can generate a collaboration score for the position based on the plurality of physical proximity scores.

### CROSS REFERENCE TO RELATED APPLICATIONS

This application claims the benefit of and priority to U.S. Application No. 63/035,379, filed Jun. 5, 2020, titled “COLLABORATION INDEX,” the disclosure of which is incorporated herein by reference in its entirety.

### TECHNICAL FIELD

The present systems and processes relate generally to machine learning-based analysis and classification of collaboration.

### BACKGROUND

Machine learning generally refers to an application of artificial intelligence (AI) that provides systems the ability to automatically learn and improve from experience without being explicitly programmed. Machine learning typically focuses on the development of computer programs that can access data and use it to learn for themselves.

Previous approaches to estimating collaborative effort of tasks and positions have typically relied upon heuristics. However, heuristics-based approaches may fail to consider or accurately weight all factors that may influence a position's collaborative quality. Accordingly, there exists an unmet need for systems and methods that can more accurately predict the collaborative nature of a role or task.

### BRIEF SUMMARY OF THE DISCLOSURE

Briefly described, and according to one embodiment, aspects of the present disclosure generally relate to systems and methods for determining whether a job position may be performed with a degree of collaboration with other coworkers.

In various embodiments, the disclosed system may receive, from a user, a job position that contains a job description, for determining the degree of collaboration a job position may entail. In one or more embodiments, a user may be a person within a company that posts job positions, or may be a system associated with a company. In at least one embodiment, the disclosed system receives a job title, the name of the company hiring for the job position, and a job description, wherein the job description is a list of skills and tasks for the job position. In one embodiment, the disclosed system receives only a job description and uses one or more machine learning algorithms to determine additional job metadata for the job description from the input data from the job description, and attaches the additional job metadata to the job description (or otherwise creates a set of metadata or parameters for the job description). In some embodiments, the disclosed system may parse proprietary databases and/or public databases to determine the job metadata for a given job description or job position. For example, in one embodiment, the disclosed system may receive a job description that includes three tasks and/or responsibilities for the job position. Continuing with this example, the disclosed system may parse a proprietary database that contains stored historical job position data, match the original tasks/responsibilities to one or more historical job positions, and attached additional tasks/responsibilities from the historical job position data to the current job description.

In multiple embodiments, the disclosed system may utilize the job position data to determine additional relevant information, such as, but not limited to, job functions and job levels, industry of the company, office locations of the company, the existing distribution of talent within the company or a concentration of talent within a particular office or area within the company, by using deep learning and natural language processing techniques, as described below. In one or more embodiments, the disclosed system may use the metadata from the job description to determine additional relevant information, such as additional skills, responsibilities, tasks, other job position titles with similar duties, and/or other information, by using additional resources such as standard occupation codes, ONET codes, or other standards, for formalizing the structure and modeling of the job position looking to be filled.

In one or more embodiments, the present system may automatically (or in response to input) collect, retrieve, or access data. In at least one embodiment, the system may automatically scrape and index publicly accessible data sources to obtain job position data and/or other information, such as job postings, job titles, date of posting, date job posting first identified, company name, location the company is hiring for, and/or job requirements including tasks and responsibilities. In one or more embodiments, the system may automatically access and process job position data and/or other information stored in one or more databases operatively connected to the system. In various embodiments, the system may retrieve data by processing electronic documents, web pages, and other digital media. In one embodiment, the system may process resumes, position descriptions, online reviews, and other digital media to obtain job position and/or other information.

In various embodiments, the disclosed system may perform entity resolution on data. As described herein, entity resolution may generally include disambiguating manifestations of real world entities in various records or mentions by linking and grouping. In one embodiment, a dataset of job position data may include a plurality of job positions for a single employer. In one or more embodiments, the system may perform entity resolution to identify data items that refer to the same employer, but may use variations of the employer's title.

In multiple embodiments, the disclosed system may include one or more machine learning models that estimate the degree of collaboration a job position may entail. In at least one embodiment, predictions generated by one or more machine learning models may be binary (e.g., exemplary predictions being “job position X is a collaborative job position” and “job position Y is not a collaborative job position”), or may be correlated to a scale (e.g., exemplary predictions being “job position X is most likely to be a collaborative job position” and “job position Y is less likely to be a collaborative job position”). In one or more embodiments, predictions may be formatted as classifications determined and assigned based on comparisons between prediction scores (generated by machine learning models) and prediction thresholds that may be predefined and/or generated according to one or more machine learning models.

In various embodiments, the system may generate or receive training sets for training machine learning models. In at least one embodiment, the system may generate or receive job position training sets for predicting whether or not, or to what degree, a job position may be performed in collaboration with coworkers. For example, the system may generate a job position training set including data describing both known collaborative job positions and known non-collaborative job positions. In the same example, the system may use the job position training set to generate and train one or more machine learning models to accurately and precisely predict a likelihood of a job position being a collaborative job position or a non-collaborative job position.

In one or more embodiments, the present system may be implemented to evaluate current job positions within a company, institution, etc. In some embodiments, the system may also identify one or more machine learning parameters (e.g., portions of data, information, etc.) that are most influential in determining likelihood of a traditionally collaborative job position turning into a non-collaborative or less collaborative job position. In at least one embodiment, the disclosed system may be used to identify and predict trends for supply and demand of collaborative job positions and non-collaborative job positions, and identify potential job position to meet supply and demand trends.

In various embodiments, the disclosed system may determine a collaborative score for each specific task in a job description, based on job metadata, the distribution of talent, the level of engagement of the talent pool, and a plurality of office locations, wherein the collaborative score for each task may be a numerical value. In several embodiments, the disclosed system may then generate a collaborative score for the job position based on the collaborative scores of the tasks in the job description. In one or more embodiments, the disclosed system may determine a collaborative classification of the job position from a set of collaborative classifications, wherein each set of collaborative classifications comprises a respective bin of a plurality of bins and the collaborative classification for the job position corresponds to a particular classification in which the collaborative score fits in the respective bin.

In one example, the disclosed system may determine that a job position has five major tasks, and may assign collaborative scores to each of the five tasks based on the job metadata, the distribution of talent, and the plurality of office locations. In the same example, the system generates an overall collaborative score from a weighted or unweighted combination of the set of collaborative scores. In the same example, based on the value of overall collaborative score, the system sorts the job position into a first bin of a plurality of bins, each pin representing a range of possible score values and each range representing a particular collaboration classification. Continuing the example, based on the assignment to the first bin, the system outputs a collaboration classification “less likely to be collaborative” (e.g., meaning that job position may have a relatively low level of collaboration amongst other coworkers).

According to a first aspect, a machine learning system, comprising: A) a data store comprising entity data for an entity, the entity data comprising data describing a plurality of individuals associated with the entity; B) at least one computing device in communication with the data store, the at least one computing device being configured to: 1) receive data describing at least one aspect of a position for the entity; 2) generate metadata for the position based on the data describing the at least one aspect of the position, the metadata comprising a plurality of skills and tasks associated with the position; 3) identify a plurality of task locations for the entity; 4) determine a distribution of capacity across the plurality of task locations based on the entity data; 5) determine a plurality of physical proximity scores for each of the plurality of skills and tasks based on the metadata and the distribution of capacity across the plurality of task locations; and 6) generate a collaboration score for the position based on the plurality of physical proximity scores.

According to a further aspect, the machine learning system of the first aspect or any other aspect, wherein the at least one computing device is further configured to generate the collaboration score via a trained machine learning model.

According to a further aspect, the machine learning system of the first aspect or any other aspect, wherein the at least one computing device is further configured to generate the trained machine learning model by: A) generating an initial machine learning model; B) training, with a training dataset, the initial machine learning model to generate one or more experimental collaboration predictions, wherein the training dataset comprises historical entity data associated with the position and one or more known collaboration outcomes associated with the historical entity data; C) determining an error of the initial machine learning model by comparing the one or more experimental collaboration predictions to the one or more known collaboration outcomes; and D) generating a secondary machine learning model by adjusting the initial machine learning model based on the error, wherein the trained machine learning model is the secondary machine learning model.

According to a further aspect, the machine learning system of the first aspect or any other aspect, wherein: A) the initial machine learning model comprises a plurality of parameters and a first set of weight values that are applied to each of the plurality of parameters, wherein: 1) the plurality of parameters are based on the plurality of physical proximity scores; and 2) the first set of weight values determines a level of contribution of each of the plurality of parameters to the collaboration score; and B) the at least one computing device is configured to generate the secondary machine learning model by: 1) determining at least one of the plurality of parameters that most contributed to the error; 2) adjusting one or more weight values of the first set of weight values that are associated with the at least one the plurality of parameters to generate a secondary set of weight values; and 3) generating the secondary machine learning model based on the plurality of parameters and the secondary set of weight values.

According to a further aspect, the machine learning system of the first aspect or any other aspect, wherein the at least one computing device is configured to generate a report comprising the collaboration score.

According to a further aspect, the machine learning system of the first aspect or any other aspect, wherein: A) the at least one computing device is configured to determine at least one physical proximity score from the plurality of physical proximity scores that most positively contributed to the collaboration score; and B) the report further comprises the at least one physical proximity score that most positively contributed to the collaboration score.

According to a further aspect, the machine learning system of the first aspect or any other aspect, wherein: A) the at least one computing device is configured to determine at least one physical proximity score from the plurality of physical proximity scores that most negatively contributed to the collaboration score; and B) the report further comprises the at least one physical proximity score that most negatively contributed to the collaboration score.

According to a second aspect, a machine learning method, comprising: A) receiving, via at least one computing device, data describing at least one aspect of a position for an entity; B) generating, via the at least one computing device, metadata for the position based on the data describing the at least one aspect of the position, the metadata comprising a plurality of skills and tasks associated with the position; C) identifying, via the at least one computing device, a plurality of task locations for the entity; D) determining, via the at least one computing device, a distribution of capacity across the plurality of task locations based on entity data comprising data describing a plurality of individuals associated with the entity; E) determining, via the at least one computing device, a plurality of physical proximity scores for each of the plurality of skills and tasks based on the metadata and the distribution of capacity across the plurality of task locations; and F) generating, via the at least one computing device, a collaboration score for the position based on the plurality of physical proximity scores.

According to a further aspect, the machine learning method of the second aspect or any other aspect, further comprising generating the collaboration score by combining the plurality of physical proximity scores for each of the plurality of skills and tasks according to a predetermined weighting.

According to a further aspect, the machine learning method of the second aspect or any other aspect, further comprising removing, from the entity data, identifying information corresponding to the plurality of individuals associated with the entity.

According to a further aspect, the machine learning method of the second aspect or any other aspect, further comprising generating a collaboration classification for the position based on the collaboration score.

According to a further aspect, the machine learning method of the second aspect or any other aspect, wherein the collaboration classification is generated according to: A)

$$c ( {x}_{i j g} ) = \{ \begin{matrix}position least likely to be collaborative if h ( {x}_{i j g} ) < {h}_{0} \\ position may be collaborative if {h}_{0} < h ( {x}_{i j g} ) < {h}_{1} \\ position more likely to be collaborative if {h}_{1} < h ( {x}_{i j g} ) < {h}_{2} \\ position most likely to be collaborative if h ( {x}_{i j g} ) > {h}_{2}\end{matrix}$$

wherein: 1) h(x_{ijg}) is the collaboration score; 2) h₀ is a predefined collaborative position threshold; 3) h₁ is a predefined potentially collaborative position threshold; 4) h₂ is a predefined likely collaborative position threshold; and 5) c(x_{ijg}) is the collaboration classification.

According to a further aspect, the machine learning method of the second aspect or any other aspect, further comprising: A) transmitting the collaboration classification and the collaboration score to a collaboration application of a computing device; and B) rendering, via the computing device, a user interface comprising the collaboration classification and the collaboration score.

According to a further aspect, the machine learning method of the second aspect or any other aspect, further comprising collecting additional data describing the position from at least one external data source, wherein the metadata comprises the additional data describing the position.

According to a third aspect, a non-transitory computer-readable medium embodying a program that, when executed by at least one computing device, causes the at least one computing device to: A) receive data describing at least one aspect of a position for an entity; B) generate metadata for the position based on the data describing the at least one aspect of the position, the metadata comprising a plurality of skills and tasks associated with the position; C) identify a plurality of task locations for the entity; D) retrieve, from a data store, entity data comprising data describing a plurality of individuals associated with the entity; E) determine a distribution of capacity across the plurality of task locations based on entity data; F) determine a plurality of physical proximity scores for each of the plurality of skills and tasks based on the metadata and the distribution of capacity across the plurality of task locations; and G) generate a collaboration score for the position based on the plurality of physical proximity scores.

According to a further aspect, the non-transitory computer-readable medium embodying a program of the third aspect or any other aspect, wherein the program further causes the at least one computing device to generate the metadata by applying one or more natural language processing techniques that determine the plurality of skills and tasks associated with the position from the data describing the position.

According to a further aspect, the non-transitory computer-readable medium embodying a program of the third aspect or any other aspect, wherein the program further causes the at least one computing device to perform entity resolution on the data describing the at least one aspect of the position prior to generating the metadata.

According to a further aspect, the non-transitory computer-readable medium embodying a program of the third aspect or any other aspect, wherein the program further causes the at least one computing device to: A) perform topic modeling on the data describing the at least one aspect of the position prior to generating the metadata, wherein the topic modeling generates one or more topics associated with the position; and B) generate at least a portion of the metadata by retrieving historical entity data that matches the one or more topics associated with the position.

According to a further aspect, the non-transitory computer-readable medium embodying a program of the third aspect or any other aspect, wherein the historical entity data comprises historical skills and tasks associated with the position.

According to a further aspect, the non-transitory computer-readable medium embodying a program of the third aspect or any other aspect, wherein the program further causes the at least one computing device to generate the metadata by performing one or more keyword matching techniques to identify subsets of the data describing the at least one aspect of the position that describe the plurality of skills and tasks associated with the position.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary recommendation system according to one embodiment of the present disclosure;

FIG. 2 illustrates an exemplary collaboration recommendation process according to one embodiment; and

FIG. 3 illustrates an exemplary machine learning process according to one embodiment.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to machine learning-based solutions for assessing collaborative qualities of jobs, tasks, and skills.

In one or more embodiments, the disclosed system analyzes a position, task, or responsibility and estimates the collaborative nature thereof. In one example, the disclosed system receives and analyzes a job description to determine whether the job description includes a known position, task, and/or skill that can be performed with a high level of collaboration between other coworkers. As will be understood from discussions herein, the system may leverage one or more machine learning derived factors as inputs into a collaboration scoring and/or classification model. In at least one embodiment, the system may use one or more machine learning techniques described herein for determining a score related to a particular feature of a job or skill or whether a particular job or skill should be performed individually or collaboratively. In some embodiments, the system may determine various other factors by one or more supervised or unsupervised machine learning models/techniques. For example, the system determines, using one or more machine learning models, a likelihood that a job or skill should be performed remotely or in person.

### Exemplary Embodiments

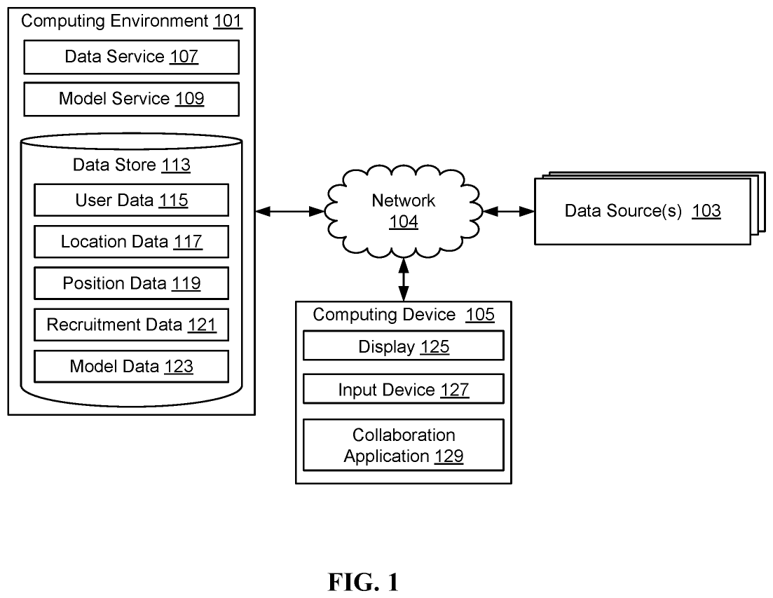

Referring now to the figures, for the purposes of example and explanation of the fundamental processes and components of the disclosed systems and processes, reference is made to FIG. 1, which illustrates an exemplary collaboration system 100. As will be understood and appreciated, the exemplary, collaboration system 100 shown in FIG. 1 represents merely one approach or embodiment of the present system, and other aspects are used according to various embodiments of the present system.

In various embodiments, the collaboration system 100 is configured to perform one or more processes for estimating and/or classifying a collaborative (or non-collaborative) nature of a position, task, or responsibility. The collaboration system 100 may include, but is not limited to, a computing environment 101, one or more data sources 103, and one or more computing devices 105 over a network 104. The network 104 includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

According to one embodiment, the computing environment 101 includes, but is not limited to, a data service 107, a model service 109, and a data store 113. The elements of the computing environment 101 can be provided via a plurality of computing devices that may be arranged, for example, in one or more server banks or computer banks or other arrangements. Such computing devices can be located in a single installation or may be distributed among many different geographical locations. For example, the computing environment 101 can include a plurality of computing devices that together may include a hosted computing resource, a grid computing resource, and/or any other distributed computing arrangement. In some cases, the computing environment 101 can correspond to an elastic computing resource where the allotted capacity of processing, network, storage, or other computing-related resources may vary over time. In one or more embodiments, the data service 107 and/or the model service 109 include one or more analysis engines hosted on a cloud hosted service (for example, Amazon Web Service™). In at least one embodiment, the computing environment 101 leverages Apache Spark, R, Python, SQL, and other tools for ingesting and processing and transforming data into particular formats for training machine learning models and generating various outputs, such as predictions of collaborative status for jobs, tasks, and skills.

The data service 107 can be configured to request, retrieve, and/or process data from data sources 103. In one example, the data service 107 is configured to automatically and periodically (e.g., every 6 hours, 3 days, 2 weeks, etc.) collect job descriptions from a database of a recruitment agency or from a company website. In another example, the data service 107 is configured to request and receive skill and task information for one or more positions from a career accreditation or certification website. In various embodiments, the data service 107 receives, retrieves, or collects position data that defines one or more qualities of a particular job, task or skill. In one example, the data service 107 receives project management data for one or more projects, and the project management data defines a hierarchy of responsibilities, skills, and tasks that the model service 109 may use as an input to estimate the degree of collaboration required for performing a similar job, skill, or task.

The data service 107 can be configured to monitor for changes to various information at a data source 103. In one example, the data service 107 scrapes public websites to monitor for changes to position data of one or more positions. In another example, the data service 107 monitors an internal employee management system for changes to position responsibilities, reporting structures, and tasks. In some embodiments, the internal employee management system can be referred to as an individual management system. The employees of an entity can be referred to as individuals associated with the entity. In this example, the data service 107 may detect that a task or responsibility previously assigned to a single position has been assigned to multiple positions. In another example the data service 107 monitors for changes to a plurality of position profiles at a company database. In this example, the data service 107 determines that additional responsibilities and tasks have been added to a particular position profile (e.g., potentially increasing a degree of collaboration required to optimally perform the role defined by the position profile). Continuing this example, in response to the determination, the data service 107 automatically collects the new position information, which may be stored in the data store 113 and leverage by the model service 109 for estimating the collaborative status of the corresponding role.

In various embodiments, the data service 107 is configured to perform analyses of various data, and the data service 107 may coordinate with the model service 109 to perform one or more analyses (e.g., the data service 107 may call the model service 109 to execute various functions). In one example, the data service 107 commands the model service 109 to analyze a job description input including a plurality of skills and tasks, analyze historical job data from one or more databases, generate associations between the plurality of skills and tasks and one or more historical job positions, and generate associations between one or more historical skills or tasks and the job description.

The data service 107 can be configured to determine likely categories or bins for various data. A bin can generally refer to any binary computer file. The data service 107 can utilize classifications and bins to determine additional relevant information that may limit or otherwise influence geographic options for fulfilling a position. As an example, the data service 107 determines that the skills and tasks “building APIs, Java, Scala, C#” fits into a bin for “software development, backend.” In some embodiments, the data service 107 can use natural language processing (NLP) to assign bins to various skills and tasks. As an example, the data service 107 can convert each of the skills and tasks into multi-dimensional vectors, and identify a closest bin based on a distance to multi-dimensional vector or areas corresponding to each bin. In some embodiments, the vectors for various bins can be tuned as new skills and tasks are assigned to the bin. Further, based on the classification, the data service 107 can match the skills and tasks to historical job positions, and the data service 107 can determine additional position metadata based on the historical job positions, such as backend web development certifications, alma maters, tenure, and performance ratings.

In another example, the data service 107 analyzes a job description for a project manager position and determines that a task quantity of 7-10 tasks fits into a middle level-bin for the task quantity being a “4 of 5 level.” In the same example, based on the classification, the data service 107 matches the job description to historical position data for positions demonstrating similar tasks and task quantities. Continuing the example, based on the historical position data, the data service 107 generates additional metadata for use in generating collaboration predictions, such as office or project hierarchies that indicate a number of employees assigned to a shared task or historical position information that indicates whether similar tasks were performed onsite or in person.

In some embodiments, the data service 107 is configured to perform one or more actions, for example, in response to input received from a computing device 105. In one example, in response to a request for collaboration information on a particular position, the data service 107 analyzes historical location data 117 and position data 119 and determines a plurality of historical tasks associated with the position and determines a historical collaboration score corresponding to the position and to each of the plurality of historical tasks. In this example, the position tasks and collaboration scores are displayed at a computing device 105 from which the request is received. In some example, the collaboration criteria can include a weighted scoring system, and the data service 107 can analyze the collaboration criteria by performing iterative regression analysis on the historical location data 117 and position data 119 to identify correlations in the data. In some embodiments, the data service 107 can use machine learning to identify optimal collaboration criterial based on the historical location data 117 and position data 119. In another example, the data service 107 identifies and transmits criteria demonstrated by one or more positions (e.g., or tasks, skills, etc.) that positively or negatively contributed to that position's predicted collaborative status. In this example, the position criteria can provide a user with an overview of exemplary qualities and other information that may be relevant to determining collaborate statuses of additional positions (e.g., or to determining assignment of tasks and other responsibilities amongst a plurality of positions). In another example, the data service 107 receives a request to evaluate a particular position (e.g., or task thereof) for collaborative status. In this example, the data service 107 retrieves position data 119 (and/or other data) with which the particular location is associated and compares the position data 119 to historical data with which the position may be associated. Continuing the example, based on the comparison, the data service 107 determines one or more criteria of the position that, when adjusted, may increase or decrease the collaborative quality of the position. In the same example, the one or more criteria are displayed on the computing device 105.

The model service 109 can be configured to perform various data analysis and modeling processes. The model service 109 can generate predictive outcomes and measures based on data associated with people, positions, companies, and industries. The model service 109 can generate, train, and execute neural networks, gradient boosting algorithms, mutual information classifiers, random forest classification, and other machine learning and related algorithms. In one or more embodiments, the model service 109 leverages one or more algorithms to evaluate, analyze, and classify data inputs, and generate and classify outputs. For example, the model service 109 leverages one or more location recommendation engine algorithms for predicting a suitable location from which to source candidates for a particular job or task. In another example, the model service 109 leverages one or more remote work classification algorithms for predicting whether a job or task should be (e.g., or can be) performed remotely or in persons.

In at least one embodiment, outputs generated by the model service 109 may be binary (e.g., exemplary predictions being “position A is collaborative” and “position B is not collaborative”), or may be correlated to a scale (e.g., exemplary predictions being “position A is more likely to be collaborative” and “location B is less likely to be collaborative”). In one or more embodiments, outputs may be formatted as classifications determined and assigned based on comparisons between prediction scores (generated by machine learning models) and prediction thresholds that may be predefined and/or generated according to one or more machine learning models.

In one example, the model service 109 generates and trains machine learning models for estimating or predicting a collaborative status of a job, task, or responsibility. In this example, the machine learning models can generate metric scores for various input data types (e.g., work scores, talent scores, collaboration scores, remote work scores, location scores, etc.), and the machine learning models can generate an estimate of collaborative status based on the metric scores. In at least one embodiment, the model service 109 generates rankings of positions, tasks, or responsibilities based on machine learning-estimated collaboration scores. In another example, the model service 109 generates and trains machine learning models for classifying job descriptions (e.g., or information derived therefrom) into one or more categories or bins.

In various embodiments, the model service 109 determines one or more optimal location from which a position may be staffed. In one or more embodiments, the model service 109 generates a recommendation for whether a position should be remote based or in person. The model service 109 can evaluate position staffing location and remote work status according to one or more embodiments described in U.S. Patent Application No. 63,035,365, filed Jun. 5, 2020, titled “LOCATION RECOMMENDATION ENGINE” or U.S. Patent Application No. 63,035,372, filed Jun. 5, 2020, titled “REMOTE ROLE RECOMMENDATION ENGINE,” the disclosures of which are incorporated herein by reference in their entireties.

The model service 109 or data service 107 can be configured to perform various data processing and normalization techniques to generate input data for machine learning and other analytical processes. Non-limiting examples of data processing techniques include, but are not limited to, entity resolution, imputation, and missing, outlier, or null value removal. In one example, the model service 109 performs entity resolution on location data for a plurality of locations to standardize terms such as position titles, company names, and task or skill descriptors. Entity resolution may generally include disambiguating manifestations of real-world entities in various records or mentions by linking and grouping. In one embodiment, a dataset of entity data may include a plurality of titles for a single position, and the model service 109 can perform entity resolution to associate the titles with the position. In one or more embodiments, the system may perform entity resolution to identify data items that refer to the same task, but may use variations of the task's title. In an exemplary scenario, a dataset may include references to a task, “project planning”; however, various dataset entries may refer to project planning as project management, project design, project organization, and other variants. In the same scenario, an embodiment of the system may perform entity resolution to identify all dataset entries that include a variation of project planning, and replace the identified dataset entries with the standard task label project planning.

The data store 113 can store various data that is accessible to the various elements of the computing environment 101. In some embodiments, data (or a subset of data) stored in the data store 113 is accessible to the computing device 105 and one or more external systems (e.g., on a secured and/or permissioned basis). Data stored at the data store 113 can include, but is not limited to, user data 115, location data 117, position data 119, recruitment data 121, and model data 123. The data store 113 can be representative of a plurality of data stores 112 as can be appreciated. In various embodiments, data is stored in various formats, including but not limited to files on Amazon's s3 service, postgres databases, and Amazon Redshift databases, optimized for retrieval or analysis.

The user data 115 can include information associated with one or more user accounts. For example, for a particular user account, the user data 115 can include, but is not limited to, an identifier, user credentials, and settings and preferences for controlling the look, feel, and function of various processes discussed herein. User credentials can include, for example, a username and password, biometric information, such as a facial or fingerprint image, or cryptographic keys such as public/private keys. Settings can include, for example, communication mode settings, alert settings, schedules for performing machine learning and/or communication generation processes, and settings for controlling which of a plurality of potential data sources 103 are leveraged to perform machine learning processes.

In one example, the settings include a configuration parameter for a particular entity, position, or entity or position location. In this example, when the configuration parameter is set to a particular region, a machine learning and/or natural language generation process can be adjusted to account for a work culture or other set of factors with which the particular region is associated. Various regions and sub-regions of the world may demonstrate varying work cultures. Because work culture may vary, data that is useful in generating effective collaboration predictions may also vary, in addition to variances in magnitudes of impact and impact directionality imposed on machine-learned predictions.

In one example, work culture of a first region is such that individuals in the region typically perform tasks only at the instruction of a superior or other coworker, and work culture of a second region is such that individuals in the region typically perform tasks independently and without substantial supervision. In this example, the computing environment 101 receives a user input requesting collaboration evaluation for a particular position in the first region, and, in response, the model service 109 configures a setting that excludes entity data associated with the second region from being utilized to evaluate collaboration of the particular position in the first region. In various embodiments, the model service 109 may configure one or more machine learning and/or NLP processes to account for variations in work culture. For example, the model service 109 may alter one or more machine learning parameter weights to reduce an impact or change impact directionality on likelihood predictions. In a particular example, work culture of an entity may be such that employees typically report to two or more superiors. Continuing the example, the model service 109 may determine that reporting to at least a threshold number of superiors (e.g., 2, 3, or 4 superiors, or any suitable number) is positively predictive for collaboration. In this example, the model service 109 may assign a positive directionality to position criteria defining a number of superiors to which a position reports (e.g., positions of the entity may be predicted to be more collaborative as the number of superiors to which the position reports increases).

The location data 117 can refer to information associated with one or more locations from which labor may be recruited. The location data 117 can include, but is not limited to, addresses for offices and other job sites, economic data associated with a particular location (e.g., housing costs, cost of living, mortgage rates, etc.), academic data associated with a particular location (e.g., average level of education, prevalence of various degrees, proximities of universities, etc.), and rules, codes, regulations, and laws associated with a particular location (for example, laws governing minimum wage, hiring quotas, benefits, etc.). The location data 117 can include weather data, crime statistics, traffic statistics, environmental data, and talent pool distribution across various tasks, skills, and job titles. The model service 109 or data service 107 can normalize various fields in location data 117, such as, for example, generating binary values “yes” or “no” values for specific rules, codes, regulations, and laws (e.g., whether minimum wage is above or below a threshold).

The position data 119 can refer to data associated with employment opportunity and fulfillment information. Position data 119 can include, but is not limited to, position titles, position duties, responsibilities, and tasks. Position data 119 may include position locations, such as, for example, a list of current and previous addresses to which candidates holding a position have been located. Position data 119 may include position fulfillment history, such as, for example, past and current position holders, position providers (e.g., institutions, companies, etc. that offer or provide labor filling particular positions), salary and/or wage information, position reviews, position provider reviews, and resumes, C.V.'s, or the like, of past and current position holders. Position data 119 may include past and current position holder education histories, job satisfaction (for example, job and/or workplace reviews related to any number of current or past-held positions), age, family status(es), marital status(es), past and current debt obligations, past and current financial health, (for example, a credit score), and social media activities. In some embodiments, the collaboration system 100 is configured to process a position holder's resume and/or employee files and determine various position data 119, such as a work history, education history, and location history. The position data 119 can include historical outputs from machine learning processes and other techniques described herein. For example, the position data 119 may include historical scores and classifications related to collaboration, staffing location, remote work, engagement, talent, costs and expenses, and/or retention. The model service 109 or data service 107 can normalize various fields in position data 119, such as, for example, adjusting title descriptions to match a predetermined title (e.g., “Sales Manager I” and “Manager of Sales I” can be adjusted to both correspond to the same position code or title).

The recruitment data 121 can refer to data associated with an employment opportunity, such as a desired set of experiences or other criteria. In one example, the recruitment data 121 includes candidate criteria, such as desired experience (e.g., skills and/or work history), location, education, compensation history and/or requirements, and other candidate qualifications. In another example, the recruitment data 121 includes location criteria defining one or more desired qualities or properties of a location from which labor may be recruited.

The recruitment data 121 can include data describing one or more candidates (e.g., generally referred to as “candidate data”). The candidate data can include, but is not limited to, candidate names, location tracking data, such as, for example, a list of current and previous addresses, education history, job satisfaction (e.g., job and/or workplace reviews), age, family status, marital status, debt obligations, financial health (for example, a credit score), and social media activities (e.g., such as a list of followers, postings, etc.). In one example, candidate data includes work history, such as past and current job titles, positions, roles, employers, salary and/or wage information, candidate performance reviews, job locations, and resumes. In at least one embodiment, personally identifying data, financial data, social media data, and other personal data (e.g., family and marital status, etc.) may not be collected or leveraged or may be intentionally excluded for processes described herein (e.g., in accordance with legal policy, corporate policy, data privacy policy, user consent parameters, etc.). In some embodiments, candidate data includes criminal records, degree history, liens, voting history, and other data obtained from investigative processes (e.g., such as information obtained from a background check performed on a particular candidate). The candidate data can include assets owned by candidates including timing information as to when those assets were purchased, such as, for example, real estate including primary residences and secondary residences, vehicles, boats, planes, and other assets. The candidate data can include current estimated values and debts associated with each asset. The model service 109 or data service 107 can normalize various fields in recruitment data 121, such as, for example, normalizing background check information to fit into predetermined bins (e.g., whether a candidate has a criminal record, whether a candidate's credit score is above a predetermined threshold, whether the candidate attended a university ranked at or above a predetermined threshold).

The model data 123 can include data associated with machine learning and other modeling processes described herein. Non-limiting examples of model data 123 include, but are not limited to, machine learning models, parameters, weight values, input and output datasets, training datasets, validation sets, configuration properties, and other settings. In one example, model data 123 includes a training dataset including historical location data 117, recruitment data 121, and position data 119. In this example, the training dataset can be used for training a machine learning model to estimate one or more optimal locations from which an entity may fill a position or task. In at least one embodiment, the model data 123 include one or more training datasets describing known jobs (e.g., or tasks, responsibilities, etc.) that can be performed with a high level of collaboration between other coworkers. In various embodiments, the model data 123 includes one or more training datasets describing known job that can be performed without a high level of collaboration between other coworkers.

In various embodiments, the model data 123 may include work culture categories that can be provided as an input to machine learning processes. In at least one embodiment, a work culture category may be used by the modeling service 109 to modify data that is input to and analyzed via one or more machine learning models. In one embodiment, a work culture category may be used by the modeling service 109 to modify outputs generated by one or more machine learning models. For example, a work culture category associated with a work culture that emphasizes in person meetings may cause a machine learning model to upgrade classifications or increase collaboration scores for positions associated with the work culture category. In one embodiment, the data stored in the data store 113 can exclude specific types of information from being used in analyses to ensure fair and equal treatment, e.g., to avoid excluding someone based on marital status, gender, race, sexual preference, etc.

In one or more embodiments, a work culture category may be used by the modeling service 109 to cause one or more machine learning models to initialize parameter weights at a higher or lower magnitude, or with a positive or negative directionality. For example, a work culture category for a “Country X” may be input to a machine learning process for predicting the collaborative nature of positions within Country X. In the same example, the Country X work culture category may cause one or more machine learning models to exclude input data related to entity data associated with locations outside of Country X (e.g., establishing that entity data outside of Country X are not predictive for predicting remote potential of positions in Country X). In some embodiments, the model service 109 identifies (e.g., and uses as an input to machine learning processes) utilities and other amenities available at the location or country with which a position is associated and that may be positively or negatively correlated with collaborative work. Examples of utilities and other amenities include, but are not limited, telecommunications infrastructure, public transportation, and available internet speeds.

In various embodiments, the data source 103 can refer to internal or external systems, pages, databases, or other platforms from which various data is received or collected. Non-limiting examples of data sources 103 include, but are not limited to, human resources systems, recruitment systems, real estate and other housing information systems, resume processing systems, applicant and talent pools, public databases (e.g., commercial record systems, tax systems, criminal record systems, company information databases, university systems, social media platforms, and etc.), private and/or permissioned databases, webpages, and financial systems. In one example, a data source 103 includes a social networking site for professional development from which the computing environment 101 collects and/or receives job descriptions and related information (e.g., such as information relating to a company associated with the job description or similar job descriptions). In another example, a data source 103 includes a geolocation service from which the computing environment 101 retrieves addresses and other location data. In another example, a data source 103 includes a database of rules, such as a corpus of active codes, regulations, and laws for a particular location.

The computing device 105 can be any network-capable device including, but not limited to, smartphones, computers, tablets, smart accessories, such as a smart watch, key fobs, and other external devices. The computing device 105 can include a processor and memory. The computing device 105 can include a display 125 on which various user interfaces can be rendered by a collaboration application 129 to configure, monitor, and control various functions of the collaboration system 100. The collaboration application 129 can correspond to a web browser and a web page, a mobile app, a native application, a service, or other software that can be executed on the computing device 105. The collaboration application 129 can display information associated with processes of the collaboration system 100 and/or data stored thereby. In one example, the collaboration application 129 displays location profiles that are generated or retrieved from the data store 113. In another example, the collaboration application 129 displays a collaboration classification of a position and a ranked list of position aspects that most heavily contributed to the classification of the position.

The computing device 105 can include an input device 127 for providing inputs, such as requests and commands, to the computing device 105. The input devices 127 can include a keyboard, mouse, pointer, touch screen, speaker for voice commands, camera or light sensing device to reach motions or gestures, or other input devices. The collaboration application 129 can process the inputs and transmit commands, requests, or responses to the computing environment 101 or one or more data sources 103. According to some embodiments, functionality of the collaboration application 129 is determined based on a particular user account or other user data 115 with which the computing device 105 is associated. In one example, a first computing device 105 is associated with a company user account and the collaboration application 129 is configured to display position profiles, including collaboration metrics, and provide access to collaboration evaluation processes. In this example, a second computing device 105 is associated with an employee user account, and the collaboration application 129 is configured to allow the computing device 105 to transmit location data 117 and position data 119 to the computing environment 101 and to display communications, such as collaboration messages and alerts.

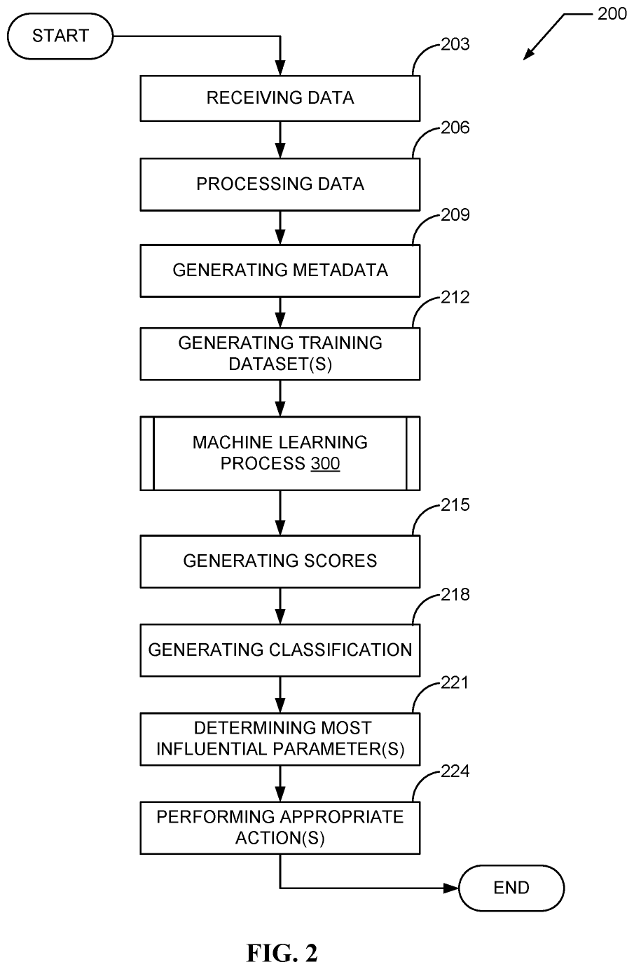

FIG. 2 shows an exemplary collaboration score generation process 200, according to one embodiment. As will be understood by one having ordinary skill in the art, the steps and processes shown in FIG. 2 (and those of all other flowcharts and sequence diagrams shown and described herein) may operate concurrently and continuously, are generally asynchronous and independent, and are not necessarily performed in the order shown. In various embodiments, by the process 200, the system determines whether a job or job description is collaborative based on one or more machine learning algorithms. In at least one embodiment, by the process 200, the system generates predictions of whether a job position may be performed with a high level of collaboration.

At step 203, the process 200 includes receiving data. As an example, the data service 107 can receive, collect, extract, or obtain data from one or more computing devices 105, data sources 103, or the data store 113. In various embodiments, the system may receive data by processing electronic documents, web pages, and other digital media from data sources 103. In one example, the data service 107 receives resumes, position descriptions, online reviews, and other digital media to obtain data that may relate to a job description (e.g., or to a position, task, skill, or title described therein).

In various embodiments, the data service 107 may receive job position data (e.g., a position title and a job description) for the data service 107 to recommend whether the associated position is collaborative or non-collaborative (e.g., independent). The job position data can be received from a user or computing device. In one or more embodiments, a user may be a person within a company that posts job positions, or may be a system associated with a company. In one example, the data service 107 receives a job description from a computing device 105 via the collaboration application 129. In at least one embodiment, the data service 107 receives a job title, the name of the company hiring for the job position, and a job description. In various embodiments, the job description includes, for example, a job title, company name, required skills, tasks to be performed, expected responsibilities, job location (e.g., including whether the job was at a specific job site or could be performed remotely or near remotely), and information that may be relevant to fulfilling position responsibilities (e.g., hierarchy of reporting, distributions of workloads, etc.). In one example, the job description includes a list of tasks and responsibilities for the job position and other criteria, such as, for example, a number of superiors to which the position reports and/or a number of current position holders at the entity (for example, a number of analysts working in a particular department).

In one or more embodiments, receiving data includes automatically (e.g., or in response to input) collecting, retrieving, or accessing data from one or more data sources 103. In at least one embodiment, the data service 107 may automatically scrape and index publicly accessible data sources to obtain job position data and/or other information. In one example, the data service 107 detects an upload of a job description to a company page on a job posting website. The data service 107 automatically collects the information for the job description and initiates the process 200 to estimate a collaborative nature of the job and generate a collaboration classification based thereon. In another example, the data service 107 detects the entry of new position data to a company's human resource system, and the data service 107 automatically scrapes the human resource system to generate a recommendation for the degree of collaboration that may be required for the associated position. The data service 107 can periodically and automatically spider or crawl over websites that include job postings to identified posted jobs and collect the data. In one or more embodiments, the data service 107 may collect, retrieve, or otherwise access job position data (and other relevant information) for determining an optimal office location from which to fill a position, and for determining whether a position may be performed remotely. In at least one embodiment, the data service may automatically process current and historical job position data stored in one or more databases to generate location, collaboration, and remote predictions described herein.

At step 206, the process 200 includes processing the data of step 203. In some embodiments, processing the data includes retrieving additional data from the data store 113 or data sources 103, such as, for example, historical position data.

The system can process data including, but is not limited to, performing text recognition and extraction techniques, data normalization techniques (e.g., such as data imputation or null value removal), entity resolution techniques, and/or (pseudo-) anonymization techniques. In at least one embodiment, processing the data includes anonymizing or pseudo-anonymizing personally-identifying information (PII). In one example, the data service 107 processes position information scraped from a company's public social media profile. In this example, the data service 107 can recognize key information and terms, such as, for example, tasks and skills for the position, position qualifications, estimated salary, company locations, and other suitable information that may influence the evaluation of the collaborative nature of the position.

In at least one embodiment, processing the data includes performing entity resolution to group and disambiguate values in the data for purposes of enabling or improving analyses of the processed data. As described herein, entity resolution may generally include disambiguating manifestations of real world entities in various records or mentions by linking and grouping. In one example a dataset of job position data may refer to a relation between labor supply and labor demand as supply-demand ratio, supply-demand coefficient, and supply-demand score. In this example, the data service 107 performs entity resolution to determine the descriptors refer to the same measure and to replace the descriptors terms with a common term (e.g., “supply-demand ratio,” or another suitable term). In one or more embodiments, supply generally refers to a location's supply of talent (e.g., talent being based on information provided and inferred about the skills, experience, and other criteria desired for the job position). In at least one embodiment, demand is the demand for talent that has those skills and experience based on aggregated and parsed job postings scraped on the internet.

In another example, the data service 107 processes a job posting and identifies a job title, tasks, responsibilities, desired experience, certifications, computer programs utilized, and company name. In the same example, the data service 107 performs an entity resolution process to replace titles and roles in the work history with industry-standardized positions.

In particular embodiments, the data service 107 generates associations between subsets of the step 203 data based on the subsets sharing similar information or attribution. For example, the data service 107 generates subsets of entity data based on individual information (e.g., similar names, contact info, work histories, locations), company information (e.g., similar names, URLs, locations, industries), and location information (e.g., similar cities, states, zip codes, coordinates). According to various aspects of the present disclosure, the data service 107 parses and normalizes the data to one or more consistent formats. In one example, for string variables, data processing techniques may include, but are not limited to, removing punctuation and extra white space, formatting the data to a consistent case (e.g., by removing all capitalization), normalizing abbreviations and fixing common spelling errors. In one embodiment, the data service 107 imputes missing values for one or more data entries, or otherwise accommodates for the missing information based on the type of model being leveraged and the impact of the missing data/value (for example, the data service 107 may exclude incomplete data from further analyses). In at least one embodiment, processing the data includes converting string values, or other non-integer-based data, to an integer or other numeric value (for example, strings may be converted to integer values via one hot encoding).

In one example, string data is cleaned and normalized to allow for precise and accurate cross-comparisons enabling the identification similarities and differences in the various data obtained at step 203. In at least one embodiment, the data service 107 classifies strings into various categories for consistency across sources. For example, classification models may be trained and leveraged to classify job titles into job levels or functions of differing granularity depending on the needs of the final model. Similar techniques may also be leveraged for classifying other data points as well, including but not limited to levels and areas of education, industries of companies, or other relevant data points that may be processed and refined to create consistency of information data that may be analyzed by one or more machine learning models. In particular embodiments, this may help to reduce noise in model development and to improve performance of final models. For example, incorrectly classifying a level of expertise (e.g., senior manager) as a level of education (e.g., MBA) would introduce noise or error into a model, and the trained models described herein may eliminate these types of errors.

At step 209, the process 200 includes generating metadata corresponding to the position (e.g., data associated therewith, such as a job description). In one or more embodiments, the data service 107 generates metadata from a job description based on natural language processing techniques, such as, for example, keyword matching and/or topic modeling. In one example, the data service 107 performs keyword matching on a job description to identify and classify subsets of the job description that describe skills, tasks, responsibilities, desired experience, pay, and other aspects of the position.

In one or more embodiments, once the disclosed system receives a job description, the system may parse the data in the job description and generate job metadata for at least one aspect of the job description. In various embodiments, the system may leverage one or more deep/machine learning and natural language processing techniques to parse and/or categorize the data from the job description. In one embodiment, the natural language processing techniques may include, but are not limited to, keyword matching and/or topic modeling. In some embodiments, the data service 107 attaches the metadata to the job position (e.g., or otherwise stores the metadata in association with the job position or entity data associated therewith).

In at least one embodiment, the data service 107 generates metadata by processing current and historical position data associated with the entity (e.g., or the position for which collaboration is being evaluated). In various embodiments, position metadata may include, but is not limited to, job position titles, job position duties, responsibilities, tasks, skills, etc., and job position locations. Additional, non-limiting examples of metadata include regional salary estimates and trends, supply to demand ratios for a particular location and/or position, talent metrics for a particular location (e.g., measures of academic achievement, productivity, tenure, etc.), talent pool growth rate, historical levels of engagement from one or more locations (e.g., tentative locations of labor pools, existing company locations, etc.), historical measures of time required to fill a role, and historical onboarding expenses.

In some embodiments, the data service 107 uses entity data to derive entity metadata via machine learning algorithms and natural language processing that utilize additional resources such as standard occupation codes, ONET codes, or other standards, for formalizing the structure and modeling of the position for which collaboration is being evaluated. For example, in one embodiment, a job description may only contain a position title, wherein the data service 107 may parse through stored information in proprietary databases and/or publicly available databases containing job position data, such as the additional resources from above, to determine the skills, tasks, and responsibilities for the job position. In one or more embodiments, the data service 107 may also determine the industry of the company from the company name, by parsing through public records and utilizing natural language processing techniques.

In one or more embodiments, the data service 107 and/or the model service 109 uses the data of steps 203-206 to determine additional relevant information, such as, for example, historical job functions and job levels, industry of the company, office locations of the company, an existing distribution of talent within the company, or a concentration of talent within a particular location, such as a company office. In some embodiments, generating the metadata includes parsing proprietary databases and/or public databases (e.g., or other data sources 103) to determine metadata for a given job description or job position. For example, in one embodiment, the data service 107 may receive a job description that includes three tasks and/or responsibilities for the job position. Continuing with the example, the data service 107 may parse a proprietary database containing stored historical job position data, and the data service 107 matches the original tasks/responsibilities to one or more historical job positions. In the same example, the data service 107 and attach additional tasks/responsibilities from the historical job position data to the current job description. In another example, the data service 107 computes a talent density metric for a particular location by analyzing historical hiring data for a plurality of locations (e.g., each location potentially having at least one person performing the position being evaluated) and determining a comparative distribution of talent throughout the plurality of locations.

In at least one embodiment, the data service 107 identifies office locations within a company by using the company name to search public records. In various embodiments, the data service 107 determines that a company that is hiring for a position by utilizing natural language processing techniques on the corresponding position description. In some embodiments, the data service 107 system determines a company name from a data source 103 associated with the company that provided the initial job position data. In one or more embodiments, in response to determining the company's, or other entity's, name, the data service 107 may determine the operating locations of the company by parsing through public records databases or other databases.

At step 212, the process 200 includes generating one or more training datasets. In various embodiments, the system may generate a first training set including two subsets of labeled data (e.g., in instances of supervised training) or two subsets of unlabeled data (e.g., in instances of unsupervised training). In at least one embodiment, a first subset of the training dataset includes historical entity data and metadata describing known job positions that require a high level of collaboration. According to one embodiment, a second subset of the training dataset includes historical entity data and metadata describing known job positions that do not require any collaboration. In various embodiments, the model service 109 uses additional training data subsets to capture collaboration classifications at higher levels of granularity. For example, the model service 109 using training data separated into a “most likely to be collaborative” subset, a “more likely to be collaborative” subset, a “likely to be collaborative” subset, a “less likely to be collaborative” subset, an “unlikely to be collaborative” subset, and a “least likely to be collaborative” subset.

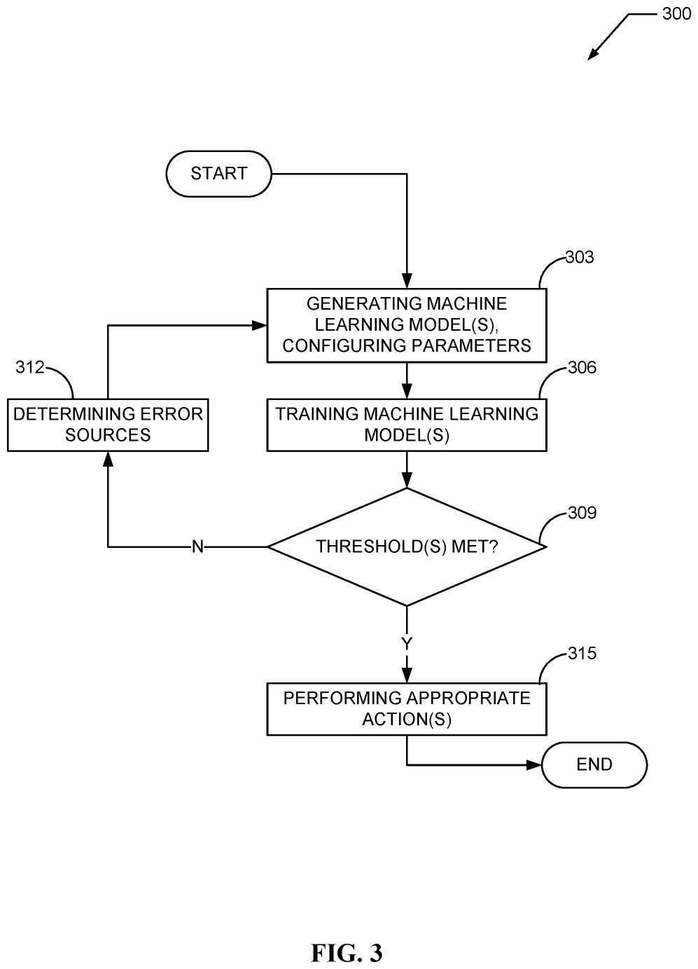

In at least one embodiment, the process 200 includes performing one or more machine learning processes 300 (FIG. 3) to generate and train machine learning models to generate various outputs, such as, for example, collaboration scores, proximity scores, talent distributions, remote work scores, location scores, and other metrics, predictions, and classifications. According to one embodiment, following generation of one or more training sets at step 212, the process 200 includes performing the machine learning process 300 to generate and train one or more machine learning models to estimate a level of collaboration associated with the position defined at step 203. In one or more embodiments, the model service 109 uses training datasets to train one or more primary machine learning models to identify differences between job positions of the known highly collaborative first portion and job positions of the known no collaboration second portion. In at least one embodiment, by identifying the differences, the one or more primary machine learning models may be trained to identify a collaboration requirement criteria that are predictive for highly collaborative or no collaboration job positions (e.g., or other, more granular collaboration classifications). According to at least one embodiment, one or more subsequent machine learning models may be created from the one or more primary machine learning models, and may be configured to analyze job positions and predict a likelihood that a job position may be highly collaborative.

In one example, an output of the machine learning process 300 includes a trained machine learning model that generates a collaboration score based on an analysis of a job description and additional information corresponding to the described position. In the same example, the trained machine learning model (e.g., or a second machine learning model) is trained to classify the position as “most likely to be collaborative,” “more likely to be collaborative,” “likely to be collaborative,” “less likely to be collaborative,” “unlikely to be collaborative,” and “least likely to be collaborative” based on the corresponding collaboration score.

At step 215, the process 200 includes generating one or more scores (e.g., or other predictions related to aspects of a job position). According to one embodiment, the collaboration score refers to a metric describing a position's collaborative, non-collaborative, or independent nature. In various embodiments, generating the one or more collaboration scores includes executing one or more trained machine learning models on the entity data received at step 203 and/or additional data and metadata derived therefrom at steps 203-209. In one or more embodiments, the trained machine learning model outputs a collaboration prediction (e.g., a Booleans, scaled integer, etc.). that describes, for the position or aspect thereof, a likelihood of the position being a highly collaborative (e.g., or non-collaborative).

The system can combine collaboration scores to generate the overall collaboration scores. As an example, the system can use predetermined weightings to combine the collaboration scores into the overall collaboration scores. In some embodiments, the system can determine weightings for combining the collaboration scores. In other embodiments, the system can receive user configurable weightings for use in combining the collaboration scores. In some embodiments, the system can determine weightings for combining the collaboration scores. The system can customize the weightings for each particular job description using metadata.

In various embodiments, the model service 109 determines a collaboration score for each specific task or responsibility in a job description (e.g., or otherwise determined from entity data or metadata). In some embodiments, the collaboration score (e.g., or other metric) computed for a particular task, responsibility, location, or other position aspect is generally referred to as a “proximity score.” In at least one embodiment, the model service 109 generates a collaborative score for the job position based on the collaborative scores of the tasks and/or responsibilities in the job description. For example, the model service 109 determines that a position has five associated tasks, predicts respective collaborative scores of 2 of 5, 4 of 5, 1 of 5, 3 of 5, 2 of 5 for each of the five tasks. Continuing with this example, the model service 109 generates a collaborative score of 2.4 of 5 for the position by averaging the collaborative scores for each of the five tasks.

In some embodiments, step 215 includes generating additional metrics (for example, additional scores) that may be weighted and combined to generate an overall location score. In one or more embodiments, additional metrics that may be weighted and combined to generate an overall location score include, but are not limited to, a location score, a remote work score, engage scores, the engage-ability of the talent pool (e.g., that may be derived from engage scores), an estimated salary range, a projected salary trend, a talent supply to demand ratio, an estimated time to fill role, a talent pool growth rate, access to high speed internet, proximity to airport, requirements for reimbursement for remote worker expenses, business environment impacts based on state and local tax laws and other relevant employment laws, and other business needs or requirements that may influence how duties and tasks of the position are performed and organized. The model service 109 can apply weights and/or directionality to one or more metrics to control an influence of the metric on the overall collaboration score. In one example, in response to the model service 109 determining that a job position has a high remote work score (e.g., meaning that the job could be “fully remote”), the model service 109 assigns a greater weight an “access to high speed internet” factor and associated metric score (e.g., because access to high speed internet may permit a greater degree of collaboration for the position).

In at least one embodiment, generating the collaboration scores includes calculating a cost for each position task or other position aspect. In some embodiments, a metric score for each additional factor refers to the calculated cost for the additional factor. In one or more embodiments, an overall collaboration score is a ratio of the total estimated costs associated with classifying the position as collaborative versus the total estimated costs associated with classifying the position as less collaborative or non-collaborative. In various embodiments, a cost refers to a direct cost or an indirect cost. In some embodiments, a direct cost may be generally defined and/or measured in terms of monetary value, such as, but not limited to, the salary for a certain job position. In at least one embodiment, the data service 107 and/or the model service 109 estimate the direct cost of an additional factor by using stored aggregated data associated with the direct cost. In various embodiments, the data service 107 and/or the model service 109 estimates the direct cost of an additional factor by using predictive modeling that may utilize additional direct costs factors, such as, for example, the rate of inflation, historical trends, and anticipated discounts (for example, discounts from additional productivity afforded by engaging a task non-collaboratively).

In one or more embodiments, an indirect cost may be generally defined and/or measured in terms of monetary value, such as, for example, access to high speed internet or the time to fill a position. In several embodiments, the data service 107 and/or the model service 109 determines a monetary value equivalent for each indirect cost such that the additional factors associated with indirect costs may be factored into a total costs algorithm (e.g., potentially in combination with additional direct costs). In one example, a certain location may lack high speed internet (e.g., maximum upload and download speeds are less than 5 MB/s), which may cause a person hired in that location to be less collaborative. In example, the data service 107 and/or the model service 109 utilize machine learning processing or other estimation tools to determine a monetary value equivalent of the indirect cost of reduced collaboration. Continuing the example, the model service 109 determines a total collaboration score at least partially based on the estimated direct cost of low speed internet and additional direct costs factors.

In at least one embodiment, the computing environment 101 receives a collaboration classification input from the user in the job description and independently determines a collaboration score or collaboration classification via machine learning models (e.g., based on the input data, job metadata, and/or other factors). In one or more embodiments, the model service 109 uses both collaboration score types to generate a collaboration prediction for the position. In some embodiments, the model service 109 prioritizes one collaboration score over the other collaboration score based on availability, predictive power, user preference, or other factors or preferences.

In various embodiments, a remote work score is a determination of whether the job position may be performed remotely, partially remotely, or on-site, or another suitable remote working classification. In one or more embodiments, the remote work score is based on a user's input in the initial job description and/or derived from one or more processes performed by the data service 107 and/or the model service 109. In at least one embodiment, the user may input a remote work classification in the job description of the job position, and the data service 107 and the model service 109 may use natural language processing and machine learning to determine the remote work score. In one example, in one embodiment, the data service 107 receives a user input indicating that the job position “may be done from home a few days a week,” and the data service 107 may process the phrase and determine that the position is partially remote. In the same example, the model service 109 assigns a remote work score to the job position based on the extracted phrase. In another example, based on historical location data 117 and position data 119 the model service 109 estimates whether a job position may be capable of being done remotely, wherein the input may be a remote work classification, such as “fully remote,” or the input may be a remote work score, which may be a numerical score.

In at least one embodiment, the computing environment 101 extracts a remote work classification input from the job description, and the computing environment 101 also independently determines a remote work score or additional remote work classification based on the job description and associated data. In various embodiments, the model service 109 utilizes both extracted and estimated remote work scores in calculating the location recommendation for the job position. In some embodiments, the model service 109 prioritizes or weights a particular remote score based on user preference, machine learning factors, or other suitable factors or preferences.

The system can generate the scores based on a step function that includes multiple functions prescribed to different intervals of input values. As an example, a first function including one or more coefficients can be used when an input value is between an interval of 0 and 1, while a second function that includes one or more other coefficients can be used when an input value is greater than 1. The system can determine or adjust the coefficients for the step function based on metadata including skills and tasks associated with the position. The system can determine or adjust the intervals for the step functions based on metadata including skills and tasks associated with the position.

In some embodiments, the computing environment 101 estimates engage-ability according to one or more embodiments described in U.S. patent application Ser. No. 16/546,849, filed Aug. 21, 2019, titled “MACHINE LEARNING SYSTEMS FOR PREDICTIVE TARGETING AND ENGAGEMENT,” the disclosure of which is incorporated herein by reference in its entirety.

In particular embodiments, a defined metric score for each associated task of a particular job position or job description is aggregated to formulate an average defined metric score. The computing environment 101 may analyze each individual defined metric score for each task of a particular job description or access the averaged defined metric score for further processing described herein. For example, if a collaboration score is measured on a scale of 0 to 5, where 5 represents “highly collaborative” and 0 represents “least collaborative”, and a plurality of collaboration scores aggregated for a particular candidate averages to 4.9, it is likely that the particular candidate is “highly collaborative”. In one or more embodiments, averaging techniques include, but are not limited to, arithmetic mean, geometric mean, harmonic mean, quadratic mean, weighted mean, root mean square, generalized mean, mode, median, and/or geometric median. In particular embodiments, the collaboration score can further be aggregated, scaled, and/or averaged for further processing desires, such as, but not limited to, error calculations, predictability, and statistical analysis.

At step 218, the process 200 includes generating a classification. In one or more embodiments, the model service 109 determines a collaborative classification of the position from a set of collaborative classifications. In at least one embodiment, each set of collaborative classification includes a respective bin of a plurality of bins and the collaborative classification for the job position corresponds to a particular classification in which the collaborative score fits in the respective bin. In one embodiment, each collaborative classification corresponds to a respective bin, so that the collaborative score fits into a bin, and the bin outputs the corresponding collaborative classification. In one example, a collaborative score of “2 of 5” for a position may correspond to a collaborative classification that predicts that the position will have a relatively low level of collaboration amongst other coworkers. In the same example, a collaborative score of 2.4 for a position may fit into a first bin that is defined as all numbers between 0-2.5. In this example, a second bin can be defined as all numbers between 2.5-3.5 and can represent a middle or average level of collaboration, and a third bin can be defined as all numbers between 3.5-5 and can represent a high level of collaboration.

In one or more embodiments, the model service 109 generates a classification of the collaboration score based on Equation 1 (which can include e.g., a step function), in which h(x_{ijg}) is a machine-learned prediction from the one or more machine-learned predictions, h₀ is a predefined “collaborative position” threshold, h₁ is a predefined “potentially collaborative position” threshold, h₂ is a predefined “likely collaborative position” threshold, and c(x_{ijg}) is the classification to which each one the one or more machine-learned predictions is assigned. In some embodiments, the process 200 only generates location scores and classifications, and does not generate a ranking.

$$( Equation 1 )$$

$$c ( {x}_{i j g} ) = \{ \begin{matrix}position least likely to be collaborative if h ( {x}_{i j g} ) < {h}_{0} \\ position may be collaborative if {h}_{0} < h ( {x}_{i j g} ) < {h}_{1} \\ position more likely to be collaborative if {h}_{1} < h ( {x}_{i j g} ) < {h}_{2} \\ position most likely to be collaborative if h ( {x}_{i j g} ) > {h}_{2}\end{matrix}$$

At step 221, the process 200 includes determining one or more parameters that were most influential to the output generated at step 215. In one or more embodiments, the model service 109 determines one or more parameters that were most negatively or positively impactful on the position's collaboration score (e.g., or other associated prediction) and, thus, on the position's collaboration classification. In one example, for a position classified as “more likely to be collaborative,” the model service 109 analyzes model data 123 associated with the location's classification to determine one or more most influential parameters. In this example, based on weight values (e.g., or other suitable measures of influence or contribution) the model service 109 determines that the position's high level of collaborative tasks and high frequency of meetings, were the most positively impacting parameters, and the model service 109 determines that the position's history of remote fulfillment was the most negatively impacting parameter. In one or more embodiments, to identify and report the most influential portions, the model service 109 determines one or more machine learning parameters (e.g., formed from the input entity data or metadata derived therefrom) that were most heavily weighted. By identifying and reporting most-weighted parameters, the system, in various embodiments, may provide for identification and tracking of parameters and job position factors that are most important in evaluating job position high collaboration or no collaboration status.

At step 224, the process 200 includes performing one or more appropriate actions. In at least one embodiment, the computing environment 100 transmits output of one or more machine learning models to one or more computing devices 105. For example, the computing environment 100 transmits a collaboration score to the collaboration application 129 and the collaboration application 129 renders the ranking on the display 125. In at least one embodiment, the computing environment 100 transmits an output in the form of an alert, text message, electronic mail, push notification, instant message, document (e.g., a word document, PDF, etc.), spreadsheet (for example, a CSV file or Excel file), or presentation file (for example, a PowerPoint file). In another example, the computing environment 101 transmits a location score and one or more additional scores (e.g., collaboration score, remote score, etc.) of a top-ranked location to the computing device 105. In another example, the computing environment 101 generates and hosts a report at a particular networking address that is accessible via the collaboration application 129 and/or a browser of the computing device 105. In another example, the computing environment 101 generates and reports a list of candidates for the particular position based on one or more top-ranked locations.

In various embodiments, the collaboration application 129 causes the computing device 105 to render an interface that includes the position classification and one or more most influential parameters associated with the classification (for example, in the form of a table or other suitable graphic). In at least one embodiment, the computing environment 101 generates a searchable report that details the position classification, each parameter of the position classification, and the metric score for each parameter.

FIG. 3 shows an exemplary machine learning process 300 (FIG. 3), according to one embodiment of the present disclosure. In some embodiments, the model service 109 leverages multiple types of machine learning models are leveraged to generate predictions that are furthermore combined into an ensemble prediction. The model service 109 can train individual models or ensemble models across a variety of hyperparameters, parameter combinations, and other factors to identify optimal model configurations through cross-validation. The model service 109 can evaluate individual or ensemble models across various methods and techniques to identify the machine learning configuration that most often correctly identifies the correct classification of the position's collaborative nature (or other aspect being evaluated).

At step 303, the process 300 includes generating one or more machine learning models for estimating the degree of collaboration associated with a particular position. In various embodiments, step 303 includes including configuring the parameters of the one or more machine learning models and, in some embodiments, adjusting weight values applied to the one or more parameters (e.g., or adjusting other model settings and properties). In one or more embodiments, step 303 includes adjusting the weight values or other transformations to reduce an error metric of the trained machine learning model and, thereby, create a secondary iteration of the machine learning model that demonstrates more accurate and/or precise performance.

In at least one embodiment, generating the machine learning model includes creating a plurality of parameters based on various factors that may influence a position's collaborative nature. In some embodiments, the model service 109 generates the plurality of parameters based on entity data and metadata derived therefrom (e.g., referring to entity data and metadata obtained via steps 203-209 of the process 200). In various embodiments, the model service 109 generates a machine learning model based on historical model data 123. For example, the model service 109 retrieves historical model data 123 that defines a trained machine learning model, and the model service 109 retrains the machine learning model using one or more training datasets (e.g., that may utilize more current data and/or may be specific to a particular position or set of positions). Non-limiting examples of machine learning models include neural networks, gradient boosting algorithms, mutual information classifiers, random forest classification, and other machine learning and related algorithms. In at least one embodiment, the model service 109 combines one or more machine learning models to generate an ensemble machine learning model.

At step 306, the process 300 includes training the machine learning model to accurately and precisely generate output, such as, for example, collaboration scores, location scores, location classifications, remote work scores, supply-demand ratios, and distributions of talent. In at least one embodiment, training the machine learning model includes executing the machine learning model on training data to generate experimental outcomes. In at least one embodiment, training the machine learning model includes generating parameters and coefficients in the machine learning model using training data that includes known outcomes such that the parameters and coefficients cause the machine learning model to be predictive for the training data of the known outcomes (e.g., based on determining correlations in inputs from the training data predictive of the known outcomes). In various embodiments, training data includes one or more training datasets generated at step 212 of the process 200 (FIG. 2) and/or training data retrieved from the data store 113 (e.g., from model data 123) or from a data source 103. In one or more embodiments, the training dataset includes a first subset of historical entity data associated with positions that are known to be collaborative and includes a second subset of historical entity data associated with positions that are known to be non-collaborative. The training dataset can include additional subsets for sub-classifications of collaboration (for example, a mostly collaborative subset, a less collaborative subset, etc.).

At step 309, the process 300 includes determining whether the machine learning model satisfies one or more accuracy, precision, and/or error thresholds based on the experimental output generated at step 306. The threshold can be predetermined (for example, the threshold can be retrieved from model data 123 and potentially determined by the system or configured by a user). In some embodiments, the system can dynamically compute the threshold, such as, for example, the system can compute the threshold using a machine learning model. In one example, the threshold is defined based on a user input (e.g., a user may select a requisite level of accuracy for the model). In another example, the threshold can be computed based on historical position information and historical entity data associated with one or more positions of the entity with which a user is associated.

In at least one embodiment, determining whether the machine learning model satisfies a threshold includes comparing experimental outcomes generated at step 306 to known outcomes of the corresponding training dataset. In one example, the model service 109 computes an error metric based on a level of similarity between the experimental outcomes and the known outcomes. In at least one embodiment, the model service compares the model error (e.g., or model accuracy, precision, etc.) to the predetermined threshold and adjusts model training based on the comparison. According to one embodiment, in response to determining the machine learning model fails to satisfy one or more thresholds, the process 300 proceeds to step 312. In various embodiments, in response to determining the machine learning model satisfies one or more thresholds, the process 300 proceeds to step 315.

At 312, the process 300 includes determining one or more sources of error, inaccuracy, or imprecision that contributed to or caused the machine learning model to violate the one or more thresholds. In at least one embodiment, the model service 109 determines one or more parameters, parameter weight values, or other model settings and properties that contributed to the model error or that, if adjusted, may improve performance of the model. In various embodiments, following step 312, the process 300 returns to step 303 and the model service 109 adjusts one or more parameters, parameter weight values, or other model settings and properties to reduce the model error.

In one example, at step 312, the model service 109 determines that a weight value for a “estimated collaborative tasks” parameter is too low and, thereby, caused the machine learning model to generate inaccurate collaboration scores or classifications (e.g., based on comparisons between known and experimental outcomes). In this example, the process 300 proceeds to step 303 and the model service 109 generates a second iteration of the machine learning model in which the weight value for the “estimated collaborative tasks” parameter is reduced. Continuing the example, the process 300 proceeds to steps 306 and the second iteration of the machine learning model generates additional experimental output for evaluation at step 309.

The system can iteratively repeat steps 303-312, thereby continuously training and/or combining the one or more machine learning models until a particular machine learning model demonstrates one or more error metrics below a predefined threshold, or demonstrates an accuracy and/or precision at or above one or more predefined thresholds.

At 315, the process 300 includes performing one or more appropriate actions. In at least one embodiment, an appropriate action includes generating location scores and/or classifications for a plurality of locations by executing the trained machine learning model on data and metadata obtained at steps 203-209 of the process 200. In one example, upon determining that an iteration of the machine learning model satisfies an error, accuracy, and/or precision threshold, the model service 109 executes the trained machine learning model on entity data of steps 203-206 and metadata derived therefrom at step 209. In this example, the trained machine learning model can generate a collaboration score for the position (e.g., or task, responsibility, etc.), and the model service 109 can classify the collaborative nature of the position according to the collaboration score.

In one or more embodiments, an appropriate action includes storing the threshold-satisfying iteration of the machine learning model as model data 123. In various embodiments, an appropriate action includes retraining the machine learning model using additional training datasets (e.g., to avoid overfitting the machine learning model to the first training dataset). In at least one embodiment, an appropriate action includes performing additional iterations of the process 300 to generate and train machine learning models for predicting other metrics, such as, for example, location scores, remote work scores, supply-demand ratios, and talent distributions. According to one embodiment, because the additional metrics may be used as inputs to the location suitability machine learning model, the model service 109 generates and trains machine learning models for estimating the additional metrics prior to training the location suitability model.

From the foregoing, it will be understood that various aspects of the processes described herein are software processes that execute on computer systems that form parts of the system. Accordingly, it will be understood that various embodiments of the system described herein can be implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. In some embodiments, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

What is claimed is:

1. A machine learning system, comprising:
a data store comprising entity data corresponding to an entity;
at least one computing device in communication with the data store, the at least one computing device being configured to:
receive data describing at least one aspect of a position for the entity;
generate metadata for the position based on the data describing the at least one aspect of the position, the metadata comprising a plurality of skills and tasks associated with the position;
identify a plurality of task locations for the entity;
determine a distribution of capacity across the plurality of task locations based on the entity data;
determine a plurality of physical proximity scores for each of the plurality of skills and tasks based on the metadata and the distribution of capacity across the plurality of task locations; and
generate a collaboration score for the position based on the plurality of physical proximity scores.

2. The machine learning system of claim 1, wherein the at least one computing device is further configured to generate the collaboration score via a trained machine learning model.

3. The machine learning system of claim 2, wherein the at least one computing device is further configured to generate the trained machine learning model by:
generating an initial machine learning model;
training, with a training dataset, the initial machine learning model to generate one or more experimental collaboration predictions, wherein the training dataset comprises historical entity data associated with the position and one or more known collaboration outcomes associated with the historical entity data;
determining an error of the initial machine learning model by comparing the one or more experimental collaboration predictions to the one or more known collaboration outcomes; and
generating a secondary machine learning model by adjusting the initial machine learning model based on the error, wherein the trained machine learning model is the secondary machine learning model.

4. The machine learning system of claim 3, wherein:
the initial machine learning model comprises a plurality of parameters and a first set of weight values that are applied to each of the plurality of parameters, wherein:
the plurality of parameters are based on the plurality of physical proximity scores; and
the first set of weight values determines a level of contribution of each of the plurality of parameters to the collaboration score; and
the at least one computing device is configured to generate the secondary machine learning model by:
determining at least one of the plurality of parameters that most contributed to the error;
adjusting one or more weight values of the first set of weight values that are associated with the at least one the plurality of parameters to generate a secondary set of weight values; and
generating the secondary machine learning model based on the plurality of parameters and the secondary set of weight values.

5. The machine learning system of claim 1, wherein the at least one computing device is configured to generate a report comprising the collaboration score.

6. The machine learning system of claim 5, wherein:
the at least one computing device is configured to determine at least one physical proximity score from the plurality of physical proximity scores that most positively contributed to the collaboration score; and
the report further comprises the at least one physical proximity score that most positively contributed to the collaboration score.

7. The machine learning system of claim 5, wherein:
the at least one computing device is configured to determine at least one physical proximity score from the plurality of physical proximity scores that most negatively contributed to the collaboration score; and
the report further comprises the at least one physical proximity score that most negatively contributed to the collaboration score.

8. A machine learning method, comprising:
receiving, via at least one computing device, data describing at least one aspect of a position for an entity;
generating, via the at least one computing device, metadata for the position based on the data describing the at least one aspect of the position, the metadata comprising a plurality of skills and tasks associated with the position;
identifying, via the at least one computing device, a plurality of task locations for the entity;
determining, via the at least one computing device, a distribution of capacity across the plurality of task locations based on entity data corresponding to the entity;
determining, via the at least one computing device, a plurality of physical proximity scores for each of the plurality of skills and tasks based on the metadata and the distribution of capacity across the plurality of task locations; and
generating, via the at least one computing device, a collaboration score for the position based on the plurality of physical proximity scores.

9. The machine learning method of claim 8, further comprising generating the collaboration score by combining the plurality of physical proximity scores for each of the plurality of skills and tasks according to a predetermined weighting.

10. The machine learning method of claim 8, wherein the entity data comprising data describing a plurality of individuals associated with the entity, and the method further comprises anonymizing the entity data to remove identifying information corresponding to the plurality of individuals associated with the entity.

11. The machine learning method of claim 8, further comprising generating a collaboration classification for the position based on the collaboration score.

12. The machine learning method of claim 11, wherein the collaboration classification is generated according to:
$$c ( {x}_{i j g} ) = \{ \begin{matrix}position least likely to be collaborative if h ( {x}_{i j g} ) < {h}_{0} \\ position may be collaborative if {h}_{0} < h ( {x}_{i j g} ) < {h}_{1} \\ position more likely to be collaborative if {h}_{1} < h ( {x}_{i j g} ) < {h}_{2} \\ position most likely to be collaborative if h ( {x}_{i j g} ) > {h}_{2}\end{matrix}$$
wherein:
h(x_{ijg}) is the collaboration score;
h₀ is a predefined collaborative position threshold;
h₁ is a predefined potentially collaborative position threshold;
h₂ is a predefined likely collaborative position threshold; and
c(x_{ijg}) is the collaboration classification.

13. The machine learning method of claim 12, further comprising:
transmitting the collaboration classification and the collaboration score to a collaboration application of a computing device; and
rendering, via the computing device, a user interface comprising the collaboration classification and the collaboration score.

14. The machine learning method of claim 8, further comprising collecting additional data describing the position from at least one external data source, wherein the metadata comprises the additional data describing the position.

15. A non-transitory computer-readable medium embodying a program that, when executed by at least one computing device, causes the at least one computing device to:
receive data describing at least one aspect of a position for an entity;
generate metadata for the position based on the data describing the at least one aspect of the position, the metadata comprising a plurality of skills and tasks associated with the position;
identify a plurality of task locations for the entity;
retrieve, from a data store, entity data corresponding to the entity;
determine a distribution of capacity across the plurality of task locations based on entity data;
determine a plurality of physical proximity scores for each of the plurality of skills and tasks based on the metadata and the distribution of capacity across the plurality of task locations; and
generate a collaboration score for the position based on the plurality of physical proximity scores.

16. The non-transitory computer-readable medium of claim 15, wherein the program further causes the at least one computing device to generate the metadata by applying one or more natural language processing techniques that determine the plurality of skills and tasks associated with the position from the data describing the position.

17. The non-transitory computer-readable medium of claim 15, wherein the program further causes the at least one computing device to perform entity resolution on the data describing the at least one aspect of the position prior to generating the metadata.

18. The non-transitory computer-readable medium of claim 15, wherein the program further causes the at least one computing device to:
perform topic modeling on the data describing the at least one aspect of the position prior to generating the metadata, wherein the topic modeling generates one or more topics associated with the position; and
generate at least a portion of the metadata by retrieving historical entity data that matches the one or more topics associated with the position.

19. The non-transitory computer-readable medium of claim 18, wherein the historical entity data comprises historical skills and tasks associated with the position.

20. The non-transitory computer-readable medium of claim 15, wherein the program further causes the at least one computing device to generate the metadata by performing one or more keyword matching techniques to identify subsets of the data describing the at least one aspect of the position that describe the plurality of skills and tasks associated with the position.
